(19) United States
(12) Patent Application Publication
(10) Pub. No.: US 2011/0310961 A1
(43) Pub. Date: Dec. 22, 2011

(54) VIDEO RATE CONTROL BASED ON TRANSFORM-COEFFICIENTS HISTOGRAM

(75) Inventors: Ronald Boskovic, Issaquah, WA (US); Tin Qian, Bellevue, WA (US)

(73) Assignee: MICROSOFT CORPORATION, Redmond, WA (US)

(21) Appl. No.: 12/818,000

(22) Filed: Jun. 17, 2010

(51) Int. Cl. H04N 7/26

(52) U.S. Cl. 375/240.03; 375/E07.139

(57) ABSTRACT

A quantization factor is determined using information from a histogram of transform coefficients that are produced from a transformed video frame. The histogram is used in estimating an encoded frame size of the video frame that is currently in the process of being encoded. The quantization factor used in the quantization step of the video encoding is adjusted for the current video frame based on the information from the histogram. The histogram is balanced against the desired length of the encoded frame size. Cutoff thresholds in the histogram correlate with different choices of quantization factors, and the ratio of points on or below those thresholds are used to estimate the size of the encoded frame.

### BACKGROUND

Video rate control dynamically adjusts encoded video quality in order to help provide a satisfactory user experience given changing networking conditions. Generally, the video encoder is given the task of matching a constant bit-rate or locally-constant bit-rate for changing networking conditions. Scene complexity changes, either by introduction of motion or cinematographic changes, can result in significant deviation from the baseline, predicted compression ratios thereby resulting in degraded video quality.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A quantization factor is determined using information from a histogram of transform coefficients that are produced from a transformed video frame. The histogram is used in estimating an encoded frame size of the video frame that is currently in the process of being encoded. The quantization factor used in the quantization step of the video encoding is adjusted for the current video frame based on the information from the histogram. Selecting a proper quantization factor assists in responding to changes (e.g. motion, scene changes) in the video frame thereby providing smoother adjustments in the quality of the video display. The histogram is balanced against the desired length of the encoded frame size. Cutoff thresholds in the histogram correlate with different choices of quantization factors, and the ratio of points on or below those thresholds are used to estimate the size of the encoded frame. Historic trends may also be used to adjust coefficients of the correlation formula as to increase the accuracy of the computation.

### BRIEF DESCRIPTION OF THE DRAWINGS

FIG. 1 illustrates a computer architecture for a computer;

FIG. 2 shows a video encoding system that incorporates the use of a histogram within the video rate control;

FIG. 3 shows exemplary graphs of compression ratio versus quantization step value and compression ratio versus percentage of non-zero coefficients;

FIG. 4 illustrates exemplary block-based intraframe/interframe compression paths that use a histogram of transform coefficients in adjusting the quantization factor; and

FIG. 5 illustrates a process 500 for updating a quantization factor using histogram information created from unquantized transform coefficients.

### DETAILED DESCRIPTION

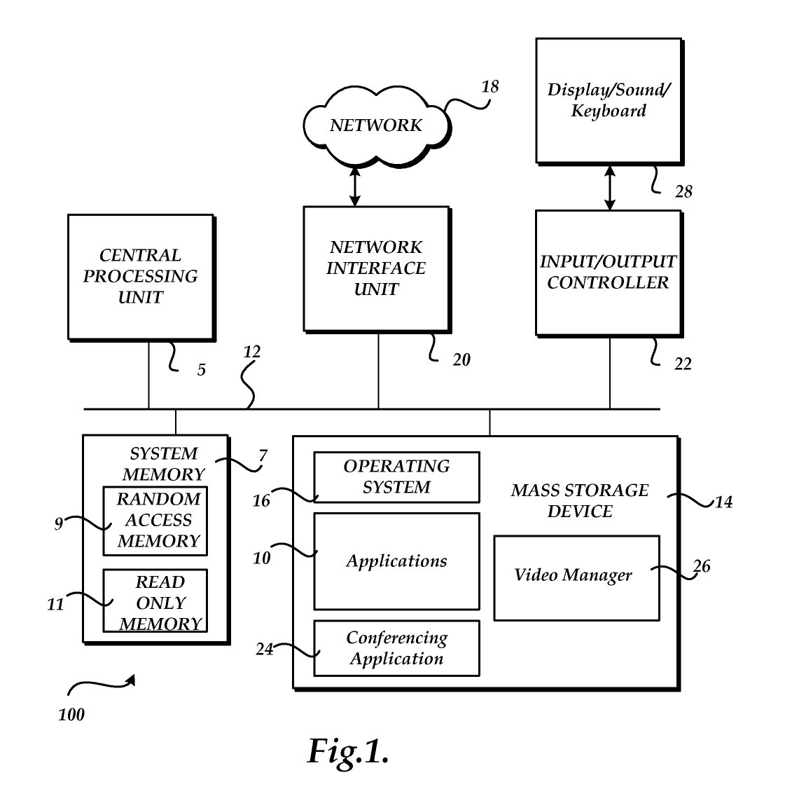

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a desktop, a server, or mobile computer and includes a central processing unit 5 (“CPU”), a system memory 7, including a random access memory 9 (“RAM”) and a read-only memory (“ROM”) 10, and a system bus 12 that couples the memory to the CPU 5. A basic input/output system containing the basic routines that help to transfer information between elements within the computer, such as during startup, is stored in the ROM 10. The computer 100 further includes a mass storage device 14 for storing an operating system 16, application programs, and other program modules, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media storage device that can be accessed by the computer 100.

The term computer readable media as used herein may include computer storage media. Computer storage media may include volatile and nonvolatile, removable and non-removable media implemented in any method or technology for storage of information, such as computer readable instructions, data structures, program modules, or other data. System memory 7, removable storage and non-removable storage are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 100. Any such computer storage media may be part of device 100. Computing device 100 may also have input device(s) 28 such as a keyboard, a mouse, a pen, a sound input device, a touch input device, etc. Output device(s) 28 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

According to various embodiments, computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, including a keyboard, mouse, or electronic stylus (not shown in FIG. 1). Similarly, an input/output controller 22 may provide output to a display screen 28, a printer, or other type of output device. Display 28 is designed to display video, such as a video feed during a video conference.

As mentioned briefly above, a number of program modules and data files may be stored in the mass storage device 14 and RAM 9 of the computer 100, including an operating system 16 suitable for controlling the operation of a networked computer, such as the WINDOWS 7® operating system from MICROSOFT CORPORATION of Redmond, Wash. The mass storage device 14 and RAM 9 may also store one or more program modules. In particular, the mass storage device 14 and the RAM 9 may store one or more application programs. One of the application programs is a conferencing application 24, such as a video conferencing application. Generally, conferencing application 24 is an application that a user utilizes when involved in a video conference between two or more users. The applications may also relate to other programs that encode video. For example, the application may encode video that is delivered to a web browser.

Video manager 26 is configured to determine a quantization factor for a current video frame based in part on a histogram of unquantized transform coefficients of the current video frame. The histogram of the transform coefficients is used in estimating an encoded frame size of the current video frame. The histogram is balanced against the desired size of the encoded frame size. Cutoff thresholds in the histogram correlate with different choices of quantization factors, and the ratio of points on or below those thresholds are used to estimate the size of the encoded frame. Historic trends may also be used to adjust coefficients of the correlation formula as to increase the accuracy of the computation. According to one embodiment, the quantization factor selected results in an encoded frame size that is similar to other encoded frame sizes that were previously produced.

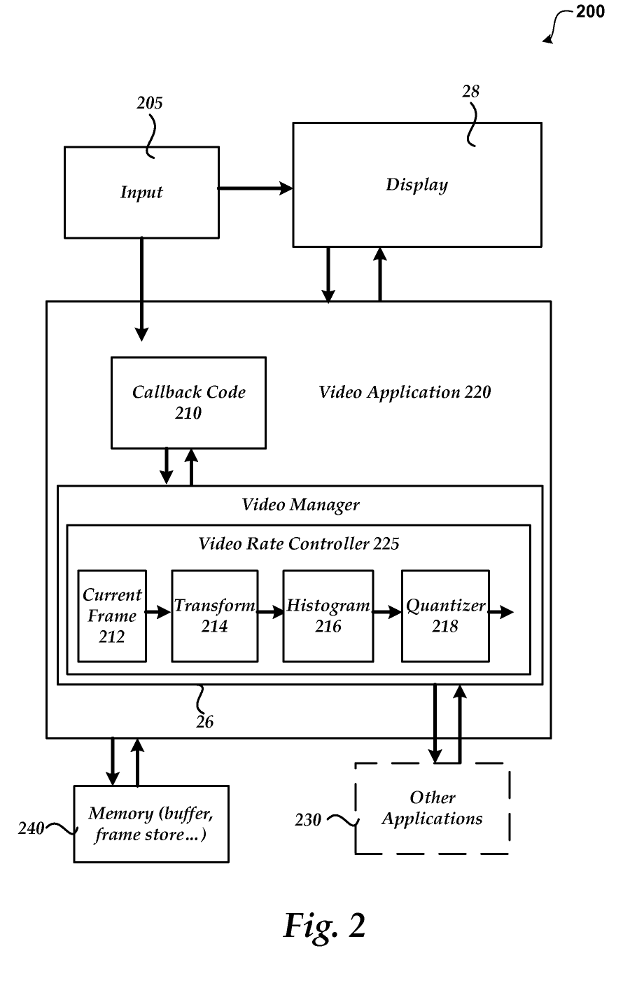

FIG. 2 shows a video encoding system that incorporates the use of a histogram within the video rate control. As illustrated, system 200 includes display 28, video manager 26, input 205, video application 220, data store 240, and other applications 230. Video manager 26 may be implemented within video application 220 as shown in FIG. 2 or may be implemented externally from application 220 as shown in FIG. 1.

In order to facilitate communication with the video manager 26, one or more callback routines, illustrated in FIG. 2 as callback code 210, may be implemented. Through the use of the callback code 210, the video manager 26 may query for additional information used in encoding video. For example, video manager 26 may request video from a buffer, such as memory 240, or some other location. Other information may also be provided that relate to the features of the video application.

Display 28 is configured to provide the user with a visual display of the encoded video. Input 205 is configured to receive input from one or more input sources, such as a video camera, keyboard, mouse, a touch screen, and/or some other input device. For example, the input may be from a video camera that supports one or more resolutions of video, such as CIF, VGA, 720P, 1080i, 1080p, and the like. Memory 240 is configured to store data that video application 220 may utilize during operation.

Video manager 26 may also coupled to other applications 230 such that video data may also be provided to and/or received from the other applications. For example, video manager 26 may be coupled to another video application and/or a networking site. As illustrated video manager 26 includes video rate controller 225 illustrates exemplary steps 212, 214, 216 and 218 that are used in the encoding process of video frames. The steps performed during the encoding process may change depending on the type of encoding performed. Compared to standard encoding schemes (e.g. H.26* and WMV*), a histogram stage 216 is included during the encoding process. The histogram stage 216 is used in determining a quantization factor used by quantizer 218. After performing the preliminary duties and sometime before quantizer 218, an estimate for the quantization factor “QP” may or may not be determined For example, the QP may be determined using history information of previous encodings and heuristics.

Part of an exemplary encoding process will now be described. Current frame 212 is received and passed to the transform process 214. The frame may be split into blocks of pixels, such as 8×8, 4×4, and the like, depending on the encoding process utilized. According to one embodiment, the transform is a Discrete Cosine Transform (“DCT”). A DCT is a type of frequency transform that converts the block (spatial information) into a block of DCT coefficients that are frequency information. The DCT operation itself is lossless or nearly lossless. Compared to the original pixel values, however, the DCT coefficients are more efficient to compress since most of the significant information is concentrated in low frequency coefficients.

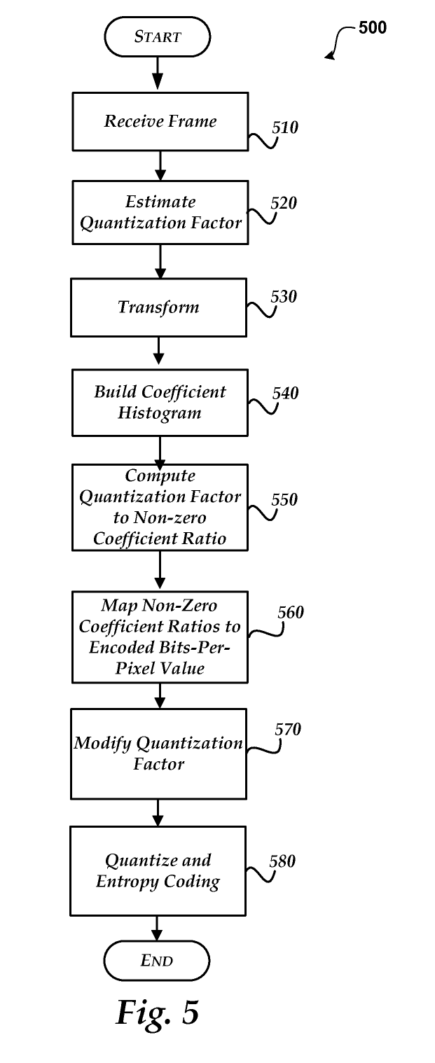

The resulting DCT transform is modified to map the resulting AC coefficients into a histogram at stage 216. After the coefficients are collected, video rate controller 225 analyzes the histogram to determine an estimated encoded frame size for the current frame being processed. The estimated encoded frame size is then used to update/determine a quantization factor to be used during the quantization process (See FIG. 5 for a more detailed description).

Quantizer 218 quantizes the transformed coefficients using the determined quantization factor. Generally, the quantization factor is applied to each coefficient, which is analogous to dividing each coefficient by the same value and rounding. For example, if a coefficient value is 130 and the quantization factor is 10, the quantized coefficient value is 13. Since low frequency DCT coefficients tend to have higher values, quantization results in loss of precision but not complete loss of the information for the coefficients. On the other hand, since high frequency DCT coefficients tend to have values of zero or close to zero, quantization of the high frequency coefficients typically results in contiguous regions of zero values. Adjusting the quantization factor based on the current frame is directed at providing a more consistent video experience for the user.

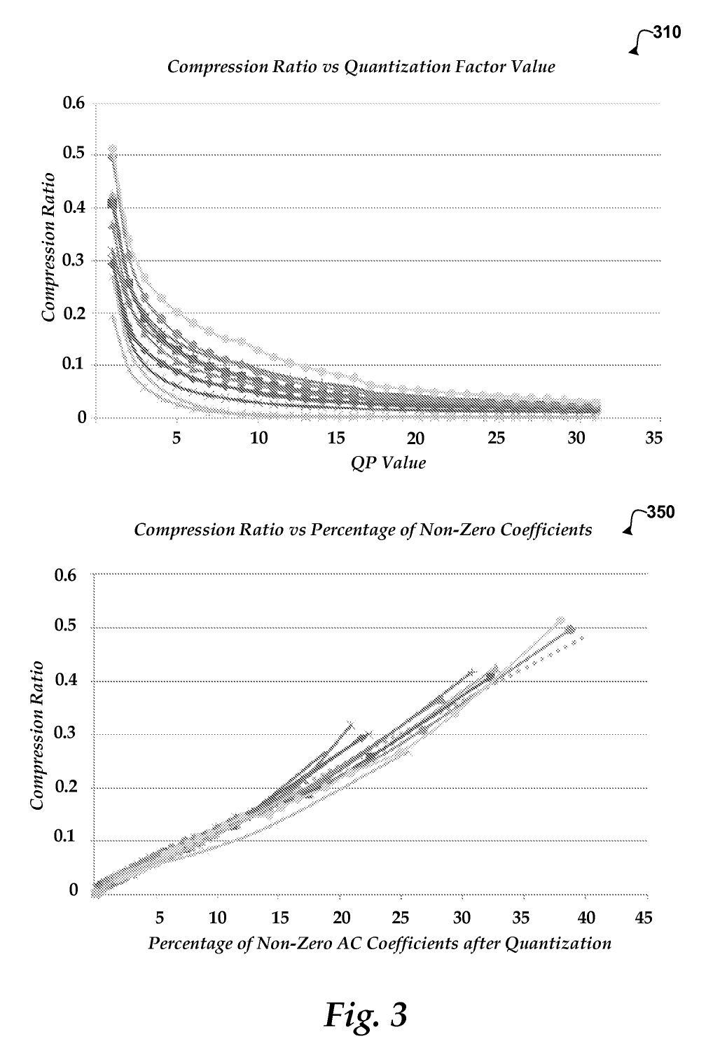

FIG. 3 shows exemplary graphs of compression ratio versus quantization step value and compression ratio versus percentage of non-zero coefficients.

Graph 310 shows a graph of compression ratio versus quantization step value. Graph 310 includes plots of 12 different videos. As can be seen, plotting the quantization step values against the compression ratio does not result in a consistent or general trend. Further, it can be seen that the difference between some of the videos is significant.

Graph 350 shows a graph of compression ratio versus percentage of non-zero coefficients based on a histogram of the unquantized transform values. Graph 350 includes plots of the 12 different videos that are also plotted in graph 310. Referring to graph 350, a correlation can be seen between the percentage of non-zero coefficients and the final encoded size. The relationship is also linear. While the trend line for graph 350 has some margin of error, it is significantly less than graph 310. The bits-per-pixel value may be approximated as an affine function of the ratio of non-zero coefficients at a certain quantization factor:

$$bpp = k * \frac{{N}_{Non - ZeroCoefficients}}{{N}_{all - coefficients}} + c .$$

According to one embodiment, while the constants k and c can be approximated using training data and heuristics, these values are continuously adjusted over the duration of a video feed (such as a video conference). This helps to ensure that effects of factors are not directly related to a non-zero coefficient ratio (e.g. DC-plane complexity, saving through frequency domain prediction, etc.). According to one embodiment, it has been found that a value for k in exemplary video conferences is about 1.1875.

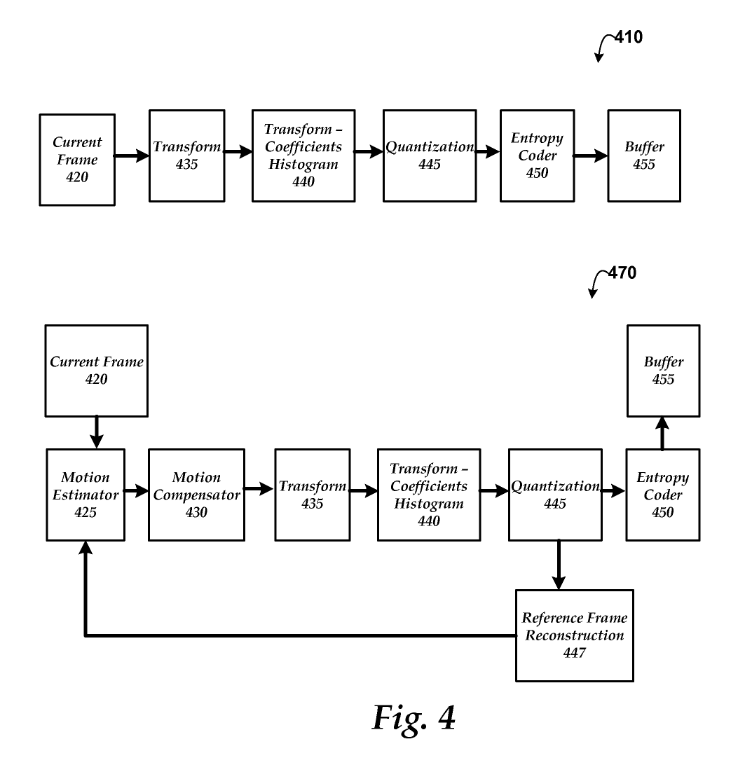

FIG. 4 illustrates an exemplary block-based intraframe/interframe compression paths that use a histogram of transform coefficients in adjusting the quantization factor. The encoder system receives a sequence of video frames including a current frame and produces compressed video as output.

The encoder system illustrated compresses predicted frames and key frames. FIG. 4 shows a path 410 for key frames through the encoder system and a path for forward-predicted frames 470. Many of the components of the encoder system are used for compressing both key frames and predicted frames. The exact operations performed by those components can vary depending on the type of information being compressed. Generally, a key frame contributes much more to bitrate than a predicted frame. In low or mid-bitrate applications, key frames can become bottlenecks for performance.

A predicted frame, also called p-frame, b-frame for bi-directional prediction, or inter-coded frame, is represented in terms of prediction (or difference) from one or more other frames. A prediction residual is the difference between what was predicted and the original frame. In contrast, a key frame, also called i-frame, intra-coded frame, is compressed without reference to other frames.

When current frame 420 is a forward-predicted frame, a motion estimator 425 estimates motion of macroblocks, or other sets of pixels, of the current frame 420 with respect to a reference frame, which is a reconstructed previous frame that may be buffered in a frame store. In alternative embodiments, the reference frame is a later frame or the current frame is bi-directionally predicted. The motion estimator 425 can estimate motion by pixel, ½ pixel, ¼ pixel, or other increments, and can switch the resolution of the motion estimation on a frame-by-frame basis or other basis. The resolution of the motion estimation can be the same or different horizontally and vertically.

A motion compensator 430 applies the motion estimation information to the reconstructed previous frame to form a motion-compensated current frame. Generally, motion estimator 425 and motion compensator 435 may be configured to apply any type of motion estimation/compensation.

A frequency transformer 435 converts the spatial domain video information into frequency domain (i.e., spectral) data. For block-based video frames, the frequency transformer 435 applies a DCT or variant of DCT to blocks of the pixel data or prediction residual data, producing blocks of DCT coefficients. Alternatively, the transformer 435 applies another conventional frequency transform such as a Fourier transform or uses wavelet or subband analysis. The frequency transformer 435 may be configured to apply an 8×8, 8×4, 4×8, or other size frequency transforms (e.g., DCT) to the frames.

Transform-Coefficients Histogram step 440 is configured to adjust a quantization factor for a current video frame based in part on a histogram that is created from the unquantized transform coefficients of the current video frame. The histogram of the transform coefficients is used in determining an estimated encoded frame size of the current video frame. The histogram is balanced against the desired size of the encoded frame size. Cutoff thresholds in the histogram correlate with different choices of quantization factors, and the ratio of points on or below those thresholds are used to estimate the size of the encoded frame. The quantization factor is selected based on the estimated encoded frame size as determined by histogram step 440.

Quantization 445 quantizes the blocks of spectral data coefficients using the quantization factor determined by histogram 440.

When a reconstructed current frame is needed for subsequent motion estimation/compensation, reference frame, reconstructor 447 performs inverse quantization on the quantized spectral data coefficients. An inverse frequency transformer then performs the inverse of the operations of the frequency transformer 435 producing a reconstructed prediction residual (for a predicted frame) or a reconstructed key frame.

When the current frame 420 is a key frame, the reconstructed key frame is taken as the reconstructed current frame (not shown). If the current frame 420 is a predicted frame, the reconstructed prediction residual is added to the motion-compensated current frame to form the reconstructed current frame. A frame store may be used to buffer the reconstructed current frame for use in predicting the next frame.

The entropy coder 450 compresses the output of the quantizer 445 as well as certain side information (e.g., motion information, spatial extrapolation modes, quantization step size). Typical entropy coding techniques include arithmetic coding, differential coding, Huffman coding, run length coding, LZ coding, dictionary coding, and combinations of the above. The entropy coder 450 typically uses different coding techniques for different kinds of information (e.g., DC coefficients, AC coefficients, different kinds of side information), and can choose from among multiple code tables within a particular coding technique. The entropy coder 450 puts compressed video information in buffer 455. Generally, compressed video information is depleted from buffer 455 at a constant or relatively constant bitrate and stored for subsequent streaming at that bitrate.

Referring now to FIG. 5, an illustrative process for coding a video frame using histogram information from unquantized transform coefficients is described.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 5 illustrates a process 500 for updating a quantization factor using histogram information created from unquantized transform coefficients.

After a start operation, the process flows to operation 510, where a video frame is received for processing. After performing any preliminary duties, which may depend on the architecture and algorithm, the process flows to operation 520.

At operation 520, an estimate for the quantization factor “QP” to be used during the quantization operation is determined. The estimated QP may be any selected QP and may correspond to the QP value(s) used in different compression standards (i.e. MPEG-1, MPEG-2, MPEG-4 ASP, H.26*, VC-3, WMV7, WMV8, VP5, VP6, MJPEG, and the like). For example, QP may be determined using history information and heuristics. The QP factor is used to reduce the magnitude of the transformed coefficients in order to provide a more compressed representation of the frame.

Moving to operation 530, the frame is transformed from one domain to another domain. According to one embodiment, the transform that is applied to the frame is a DCT.

Flowing to operation 540, the resulting DCT is modified to map the resulting AC coefficients into a histogram. According to one embodiment, the histogram spans the full range of values corresponding to quantization levels that may or may not be divided into bins. After the coefficients are collected, the histogram is analyzed to determine an update to the quantization factor.

Moving to operation 550, the quantization factor to non-zero coefficient ratio is computed. Each possible quantization factor divides the coefficients into two groups: (1) the coefficients that will be rounded to zero after the quantization step; and (2) the coefficients that will not be rounded to zero after the quantization step. According to one embodiment, a table is created where each quantization factor is mapped to the ratio of non-zero coefficients to zero coefficients after corresponding quantization step.

Flowing to operation 560, the ratios are then mapped to an encoded-bits-per-pixel value using a multi-parameter polynomial. Knowing the frame size (i.e. image dimensions) those values are mapped to a predicted encoded frame size.

Transitioning to operation 570, the quantization factor that was initially estimated is updated to reflect the information obtained in operations 540-560. According to one embodiment, the quantization factor is modified such that the encoded frame size is similar to previous encoded frame sizes. Keeping the encoded frame size within a range of acceptable values helps in maintaining the quality level of the encoded video without exceeding the buffer. Adjusting the quantization factor based on the current frame helps in reacting more quickly to the changes in scene complexity as compared to using only the history thereby resulting in a better end user experience, fewer dropped frames and a reduction in the amount of QP level fluctuation of information is used to improve the initial quantization factor estimate.

Moving to operation 580, the current frame is quantized using the updated quantization factor and then entropy coded.

The process then flows to an end operation and returns to processing other actions.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for determining a quantization factor during encoding of a video frame, comprising:
receiving a video frame comprising pixels;
applying a transform to the video frame; wherein the transform is a frequency transform that produces transform coefficients;
creating a histogram using the transform coefficients from the transformed video frame; and
determining a quantization factor using information from the histogram; wherein the quantization factor is used during quantization of the transform coefficients.

2. The method of claim 1, further comprising estimating an encoded size of the video frame using the histogram before the video frame is encoded.

3. The method of claim 2, wherein the video frame is a current video frame that is in the process of being encoded and wherein creating the histogram comprises creating the histogram from the transform coefficients of the current video frame.

4. The method of claim 2, wherein creating the histogram comprises using a cutoff threshold in determining the quantization factor.

5. The method of claim 2, further comprising using historic trends to adjust the determined quantization factor.

6. The method of claim 2, further comprising computing ratios of non-zero coefficients after quantization using different quantization values.

7. The method of claim 2, further comprising mapping the non-zero coefficient ratios to an encoded bits-per-pixel value.

8. The method of claim 7, wherein determining the quantization factor comprises modifying an estimated quantization factor that is determined before creating the histogram.

9. A computer-readable storage medium having computer-executable instructions for determining a quantization factor, comprising:
receiving a video frame comprising pixels;
applying a frequency transform to the video frame; wherein the transform produces transform coefficients;
estimating a quantization factor to be used during quantization of the transform coefficients;
before the quantization of the transform coefficients, creating a histogram using the transform coefficients; and
updating the quantization factor using information from the histogram.

10. The computer-readable storage medium of claim 9, further comprising estimating an encoded size of the video frame using the histogram before the video frame is encoded.

11. The computer-readable storage medium of claim 10, wherein the video frame is a current video frame that is in the process of being encoded.

12. The computer-readable storage medium of claim 10, further comprising determining ratios of non-zero AC coefficients after quantization using different quantization values.

13. The computer-readable storage medium of claim 10, further comprising mapping the ratios to an encoded bits-per-pixel value.

14. The computer-readable storage medium of claim 10, wherein updating the quantization factor comprises selecting a quantization value that keeps the encoded frame size of the video frame similar to previously encoded frame sizes.

15. The computer-readable storage medium of claim 10, wherein estimating the quantization factor is determined before creating the histogram.

16. A system for determining a quantization factor, comprising:
a processor and a computer-readable medium;
an operating environment stored on the computer-readable medium and executing on the processor;
a video application and a video manager operating on the processor;
and configured to perform tasks, comprising:
receiving a video frame comprising pixels;
applying a frequency transform to the video frame; wherein the transform produces transform coefficients;
before the quantization of the transform coefficients, creating a histogram using the transform coefficients; and
determining the quantization factor using information from the histogram and an estimated encoded size of the video frame.

17. The system of claim 10, wherein the video frame is a current video frame that is in the process of being encoded.

18. The system of claim 17, further comprising determining ratios of non-zero AC coefficients after quantization using different quantization values.

19. The system of claim 18, further comprising mapping the ratios to an encoded bits-per-pixel value.

20. The system of claim 10, wherein determining the quantization factor comprises updating an estimated quantization value that is determined before creating the histogram.
